(19) United States
(12) Patent Application Publication
(10) Pub. No.: US 2025/0229223 A1
(43) Pub. Date: Jul. 17, 2025

(54) CARBON DIOXIDE FIXATION METHOD AND CARBON DIOXIDE FIXATION SYSTEM

(71) Applicant: TOYOTA JIDOSHA KABUSHIKI KAISHA, Toyota-shi (JP)

(72) Inventors: Yoshiteru YAZAWA, Nagoya-shi (JP); Koseki SUGIYAMA, Sunto-gun (JP); Akira KATO, Toyota-shi (JP); Masahiko TAKEUCHI, Toyota-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 18/906,546

(22) Filed: Oct. 4, 2024

(30) Foreign Application Priority Data
Jan. 15, 2024 (JP) 2024-004053

(51) Int. Cl. B01D 53/78; C02F 1/44; C02F 103/08

(52) U.S. Cl. CPC B01D 53/78; C02F 1/441; C02F 2103/08

(57) ABSTRACT

A method for immobilizing carbon dioxide includes the steps of desalinating seawater to produce fresh water 13 and concentrated seawater 14; extracting NaOH or HCl from the seawater, adjusting pH of the seawater using NaOH or HCl; and fixing carbon dioxide to a mineral source contained in the concentrated seawater by supplying a gas containing carbon dioxide to the concentrated seawater.

### CROSS-REFERENCE TO RELATED APPLICATION

This application claims priority to Japanese Patent Application No. 2024-004053 filed on Jan. 15, 2024, incorporated herein by reference in its entirety.

### BACKGROUND

### 1. Technical Field

The present disclosure relates to a carbon dioxide fixation method and a carbon dioxide fixation system.

### 2. Description of Related Art

Japanese Unexamined Patent Application Publication No. 2023-131882 (JP 2023-131882 A) discloses a collection system for collecting carbon dioxide (CO₂) that is a greenhouse gas. The collection system of JP 2023-131882 A uses an amine-based compound as an absorption liquid that absorbs carbon dioxide gas contained in exhaust gas. The collection system includes a processing unit including an anion exchange membrane, a cation exchange membrane, and a bipolar membrane.

### SUMMARY

Methods for fixing carbon dioxide using mineral sources such as calcium (Ca) and magnesium (Mg) have been developed. For example, carbon dioxide can be fixed by reacting carbon dioxide with the mineral source to cause carbonation. Carbon dioxide can be fixed by producing carbonates such as calcium carbonate (CaCO₃), magnesium carbonate (MgCO₃), or double salts thereof (CaMg(CO₃)₂).

Seawater contains mineral sources such as calcium and magnesium. However, there is a problem in that the concentration of the mineral sources is low in seawater and therefore carbon dioxide cannot be fixed efficiently. Thus, there is a demand for development of a more efficient carbon dioxide fixation technology.

The present disclosure has been made in view of the above problem, and an object thereof is to provide a carbon dioxide fixation method and a carbon dioxide fixation system capable of efficiently fixing carbon dioxide.

In order to solve the above problem and achieve the above object, the following carbon dioxide fixation method and the following carbon dioxide fixation system are provided.

A carbon dioxide fixation method according to the present disclosure includes:
desalinating seawater to produce fresh water and concentrated seawater;
extracting NaOH or HCl from the seawater;
adjusting pH of the seawater using the NaOH or the HCl; and
fixing carbon dioxide to a mineral source contained in the concentrated seawater by supplying gas containing the carbon dioxide to the concentrated seawater.

In the above fixation method,
in the desalinating of the seawater, the fresh water and the concentrated seawater may be separated using a reverse osmosis membrane.

In the above fixation method,
carbon dioxide gas contained in exhaust gas discharged from a factory or a plant may be supplied to the concentrated seawater.

In the above fixation method,
the fresh water may be used as a coolant for the factory or the plant that discharges the exhaust gas.

A carbon dioxide fixation system according to the present disclosure includes:
a desalination unit configured to desalinate seawater to produce fresh water and concentrated seawater;
an extraction unit configured to extract NaOH or HCl for adjustment of pH from the seawater; and
a fixation unit configured to fix carbon dioxide to a mineral source contained in the concentrated seawater by supplying gas containing the carbon dioxide to the concentrated seawater.

According to the present disclosure, it is possible to provide the carbon dioxide fixation method and the carbon dioxide fixation system capable of efficiently fixing carbon dioxide.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an overall configuration of an immobilization system according to a first embodiment;

FIG. 2 is a schematic diagram for explaining a bipolar membrane electrodialysis method;

FIG. 3 is a flow chart showing a carbon dioxide immobilization process; and

FIG. 4 is a block diagram illustrating an overall configuration of the immobilization system according to the second embodiment.

### DETAILED DESCRIPTION OF EMBODIMENTS

Hereinafter, embodiments of the present disclosure will be described with reference to the drawings. However, the disclosure according to the claims is not limited to the following embodiments. Moreover, all of the configurations described in the embodiments are not necessarily indispensable as means for solving the issue. In order to clarify the explanation, the following description and drawings have been omitted or simplified as appropriate. In each drawing, the same elements are designated by the same reference signs, and duplicate explanations are omitted as necessary.

### First Embodiment

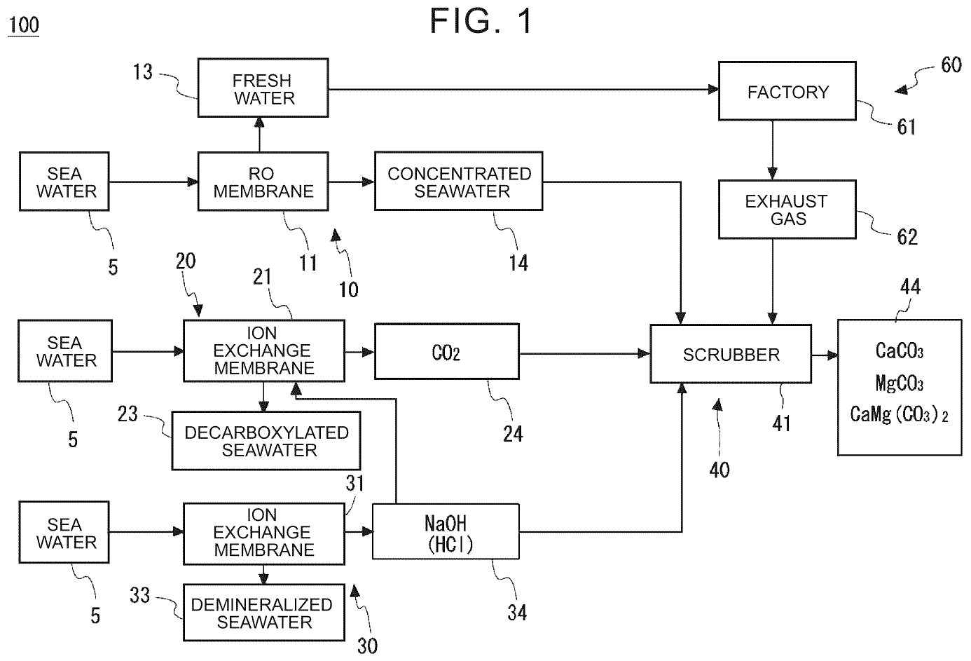

With reference to FIG. 1, a carbon dioxide immobilization system 100 will be described. FIG. 1 is a block diagram illustrating a configuration of an entire system. As illustrated in FIG. 1, the immobilization system 100 includes a desalination unit 10, a recovery unit 20, an extraction unit 30, a fixation unit 40, and a gas supply unit 60. The desalination unit 10, the recovery unit 20, the extraction unit 30, the fixation unit 40, and the gas supply unit 60 are connected by a pipe or the like. Seawater 5 is supplied to the desalination unit 10, the recovery unit 20, and the extraction unit 30. For example, a pump or the like sucks the seawater 5 in a shallow region of the sea. Then, the seawater 5 is supplied to the desalination unit 10, the recovery unit 20, and the extraction unit 30 through the pipe.

The desalination unit 10 is, for example, a carbohydrate plant. The desalination unit 10 includes a Reverse Osmosis (RO) membrane 11 for desalinating the seawater 5. Reverse Osmosis (RO) membrane 11 is a reverse-osmosis membrane that permeates only water molecules and does not permeate materials dissolved in water. The water molecules in the seawater permeate through RO membrane 11, thereby forming fresh water 13.

In addition, mineral sources such as calcium and magnesium are concentrated in seawater that does not permeate through RO membrane 11. The seawater in which the mineral source is concentrated is referred to as concentrated seawater 14. By using RO membrane 11, the concentrated seawater 14 is generated when the fresh water 13 is generated. The desalination unit 10 may separate the seawater into concentrated seawater 14 and freshwater 13. In the concentrated seawater 14, the concentration of mineral sources such as calcium and magnesium is higher than that in seawater.

The concentrated seawater 14 generated by the desalination unit 10 is supplied to the fixation unit 40. The fresh water 13 generated by the desalination unit 10 is supplied to the gas supply unit 60. The gas supply unit 60 is installed in a factory 61, a plant, or the like. In the factory 61, the fresh water 13 may be used as coolant. For example, the fresh water 13 cools the heat source in the factory 61.

The fresh water 13 is not limited to the factory 61, power generation plant, chemical plant, petroleum plant, gas plant, botanical plant, steel plant, may be supplied to various plants such as mining plant. Alternatively, at least a part of the fresh water 13 may be used as water for plant cultivation. For example, the fresh water 13 is supplied to a plant factory or a botanical plant and used for hydroponic cultivation or the like. The facility in which the fresh water 13 is used is not particularly limited.

The extraction unit 30 extracts sodium hydroxide 34 (hereinafter also referred to as NaOH) from the seawater 5. For example, the extraction unit 30 includes an ion exchange membrane 31. Specifically, NaOH is extracted from the seawater 5 by electrodialysis using the ion exchange membrane 31. By using the electrodialysis method, NaOH is precipitated. The seawater from which NaOH has been extracted becomes demineralized seawater 33. NaOH is supplied to the fixation unit 40 to adjust pH.

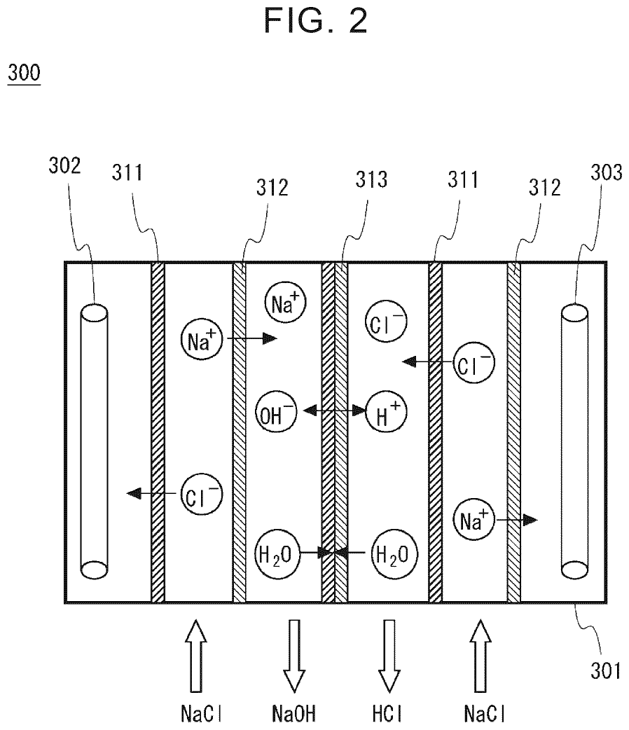

For example, NaOH, and hydrochloric acid (HCl) are extracted by Bipolar Membrane Electrodialysis (BMED) using an anion-exchange membrane, a cation-exchange membrane, and a bipolar membrane. FIG. 2 is a schematic diagram for explaining the electrodialysis apparatus 300 of the bipolar membrane electrodialysis method.

The storage tank 301 is a tank for storing seawater 5 containing sodium chloride (NaCl). The storage tank 301 is provided with an anode 302 and a cathode 303. In the storage tank 301, an anion exchange membrane 311, a cation exchange membrane 312, and a bipolar membrane 313 are disposed between the anode 302 and the cathode 303. From the anode 302 side, an anion exchange membrane 311, a cation exchange membrane 312, a bipolar membrane 313, an anion exchange membrane 311, and a cation exchange membrane 312 are arranged in this order.

Seawater containing NaCl is supplied to the compartment between the anion exchange membrane 311 and the cation exchange membrane 312. The anion exchange membrane 311 passes through the anions and blocks the passage of cations. Therefore, Cl-in the sea water passes through the anion exchange membrane 311 toward the anode 302. The cation exchange membrane 312 passes through the cations and blocks the passage of anions. Therefore, Na⁺ in the sea water passes through the cation exchange membrane 312 toward the cathode 303.

The bipolar membrane 313 is an ion exchange membrane in which the anion exchange membrane 311 and the cation exchange membrane 312 are bonded to each other. The bipolar membrane 313 dissociates water molecules (H₂O) into H₊ and OH by application of a voltage. The H⁺ migrates to the compartment between the bipolar membrane 313 and the anion exchange membrane 311. OH migrates to the compartment between the cation exchange membrane 312 and the bipolar membrane 313. Accordingly, HCl is extracted from the compartment between the bipolar membrane 313 and the anion exchange membrane 311. NaOH is extracted from the compartment between the cation exchange membrane 312 and the bipolar membrane 313.

As shown in FIG. 1, NaOH for making pH alkaline is supplied to the fixation unit 40. Further, NaOH may be supplied to the recovery unit 20. Further, HCl for acidifying pH may be supplied to the recovery unit 20. The extraction unit 30 is not limited to the electrodialysis method, and may extract NaOH by electrolysis of seawater.

The recovery unit 20 recovers carbon dioxide 24 (hereinafter, also referred to as CO₂) from the seawater 5. The recovery unit 20 includes an ion-exchange membrane 21 for recovering CO₂. For example, the recovery unit 20 recovers CO₂ by electrodialysis using the ion-exchange membrane 21. Anion exchange membranes, cation exchange membranes, and Bipolar Membrane Electrodialysis (BMED) using bipolar membranes can be utilized. Specifically, CO2 is recovered using the technique described in WO 2022/99174. Further, the recovery unit 20 can recover the carbon dioxide 24 as CO₂ gases

by lowering pH of the seawater. For example, the recovery unit 20 supplies HCl to the seawater 5 to make the seawater 5 acidic. Alternatively, the recovery unit 20 increases pH of the seawater, so that the carbon dioxide becomes carbonate. That is, by supplying sodium hydroxide 34 to the seawater, the seawater 5 becomes alkaline. In this case, carbonate ions are produced. Therefore, when a mineral source such as Mg or Ca is contained in the sea water, it is precipitated as carbonate.

In the gas supply unit 60, gas containing carbon dioxide (CO₂) is supplied to the fixation unit 40. Specifically, the exhaust gas 62 is discharged from the factory 61. The exhaust gas 62 is, for example, combustion gas generated when the hydrocarbon-based fuel is burned. The exhaust gas 62 contains carbon dioxide gas at a high concentration of, for example, 10 to 15%.

The exhaust gas 62 is supplied to the fixation unit 40. Here, the exhaust gas 62 containing carbon dioxide gas may be supplied to the fixation unit 40 through a pipe installed between the factory 61 and the fixation unit 40. Alternatively, the carbon dioxide gas may be supplied to the fixation unit 40 via the adsorbent or the absorber.

As described above, the concentrated seawater 14 and the exhaust gas 62 are supplied to the fixation unit 40. The fixation unit 40 includes a scrubber 41. The concentrated seawater 14 and the exhaust gas 62 are supplied to the scrubber 41. The scrubber 41 performs exhaust gas treatment using the concentrated seawater 14 containing carbon dioxide gas as a treatment liquid.

For example, the scrubber 41 includes a tank for storing the concentrated seawater 14, an inlet for introducing the exhaust gas 62 is connected, and a nozzle for generating bubbles in the scrubber 41. By the operation of the scrubber 41, carbon dioxide is immobilized on the mineral source contained in the concentrated seawater 14. That is, carbonate 44 such as calcium carbonate (CaCO₃), magnesium carbonate (MgCO₃), and calcium magnesium carbonate (CaMg(CO₃)₂) is produced.

The fixation unit 40 immobilizes carbon dioxide on a mineral source contained in the concentrated seawater generated during desalination. Concentrated seawater 14 has a higher concentration of calcium and magnesium than normal seawater. Since the concentration of the mineral source is high in the concentrated seawater 14, it is possible to efficiently fix carbon dioxide.

The gas supply unit 60 supplies a gas containing carbon dioxide gas to the fixation unit 40. The gas supply unit 60 supplies the exhaust gas 62 having a high carbon dioxide concentration to the scrubber 41. Therefore, the fixation unit 40 can efficiently immobilize carbon dioxide on calcium or magnesium. A mixture containing a high concentration of carbon dioxide gas is treated with a scrubber 41. Therefore, carbonates such as calcium carbonate, magnesium carbonate, and calcium magnesium carbonate can be efficiently produced.

Further, NaOH extracted by the extraction unit 30 is supplied to the fixation unit 40. By supplying NaOH to the concentrated seawater 14, pH of the mixed liquid can be adjusted. NaOH may be supplied as solids to the concentrated seawater 14 or as an aqueous solution. Here, NaOH is added to the concentrated seawater 14 so that pH of the concentrated seawater 14 is equal to or greater than 12. The scrubber 41 generates bubbles in the mixed liquid in which NaOH and the exhaust gas 62 are mixed with the concentrated seawater 14.

By making pH of the mixed liquid alkaline, it is possible to efficiently fix carbon dioxide. The higher pH of the admixture, the lower the solubility of the carbonate. In particular, when pH is 12 or more, the solubility is extremely low. Therefore, NaOH is added to the concentrated seawater 14 so that pH of the mixed liquid is 12 or more. As a result, more carbonate 44 can be precipitated from the concentrated seawater, so that the carbon dioxide can be efficiently fixed. Calcium carbonate, magnesium carbonate, or the like may be used as an industrial raw material. Alternatively, it may be stored underground or in the sea as a carbonate mineral.

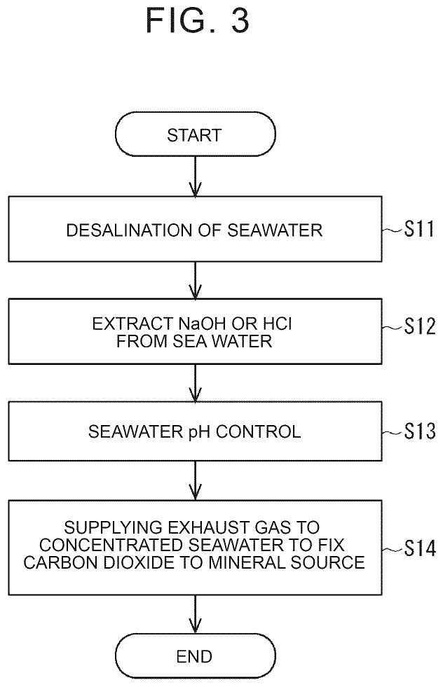

FIG. 3 is a flow chart illustrating a method for immobilizing carbon dioxide. First, the desalination unit 10 desalinates the seawater 5 (S11). The desalination unit 10 generates the fresh water 13 and the concentrated seawater 14 using RO membrane 11.

Next, the extraction unit 30 extracts NaOH or HCl from the seawater 5 (S12). Here, as described above, the electrodialysis apparatus 300 or the like extracts NaOH and HCl.

The fixation unit 40 adjusts pH of the seawater (S13). For example, by supplying NaOH to the concentrated seawater 14, the concentrated seawater 14 becomes alkaline. Here, it is preferable to add NaOH so that pH of the mixed liquid is 12 or more. In addition, pH of the seawater 5 may be adjusted in the recovery unit 20. For example, HCl is added to seawater 5 to extract carbon dioxide as gases. As a result, the seawater 5 becomes acidic.

The fixation unit 40 supplies the exhaust gas 62 to the concentrated seawater 14 to fix the carbon dioxide to the mineral source (S14). Specifically, the scrubber 41 processes the concentrated seawater 14 containing the exhaust gas 62 to produce carbonate. In this way, the carbon dioxide can be efficiently fixed.

### Second Embodiment

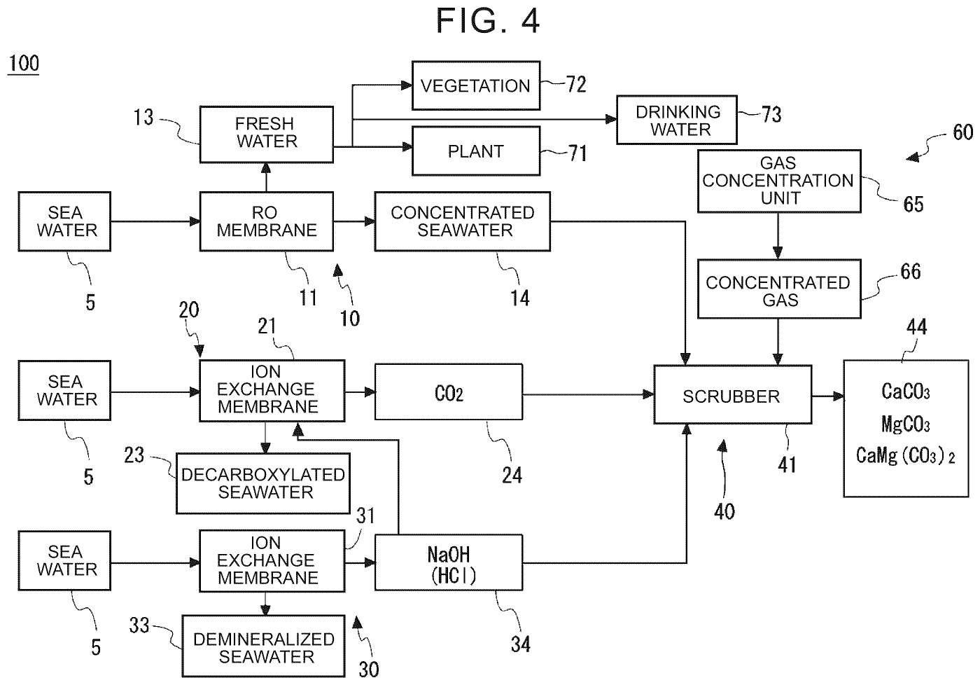

The immobilization method and the immobilization system according to the second embodiment will be described with reference to FIG. 4. FIG. 4 is a block diagram showing an overall configuration of the immobilization system. In the second embodiment, the configuration of the gas supply unit 60 is different from that in the first embodiment. Configurations other than the gas supply unit 60 are the same as those of the first embodiment, and thus description thereof will be omitted as appropriate.

The gas supply unit 60 includes a gas concentration unit 65. The gas concentration unit 65 takes in the atmosphere and concentrates the carbon dioxide gas in the atmosphere. The gas concentration unit 65 includes, for example, a separation membrane that separates the carbon dioxide gas. The separation membrane is formed of a polymer membrane, an ionic liquid membrane, or the like. The separation membrane selectively transmits carbon dioxide. Separation membranes may be arranged in multiple stages in the gas concentration unit 65. As described above, the gas concentration unit 65 generates the concentrated gas 66 in which the carbon dioxide gas is concentrated. The concentrated gas 66 is a gas containing carbon dioxide gas having a concentration higher than the concentration of carbon dioxide gas in the atmosphere.

Then, the gas supply unit 60 supplies the concentrated gas 66 generated by the gas concentration unit 65 to the fixation unit 40. The fresh water 13 generated by the desalination unit 10 is supplied to a plant 71 and vegetation 72. Fresh water 13 is used as coolant in plant 71. It may be used to grow vegetation 72. Further, fresh water 13 may be used as drinking water 73.

Also in the immobilization system 100 of the present embodiment, as described in Embodiment 1, the exhaust gas 62 of the factory 61 or the plant 71 may be supplied to the fixation unit 40. Further, the gas concentration unit 65 may concentrate the carbon dioxide gas of the exhaust gas to generate the concentrated gas 66.

The present disclosure is not limited to the above embodiments, and can be appropriately modified without departing from the spirit.

What is claimed is:

1. A carbon dioxide fixation method comprising:
desalinating seawater to produce fresh water and concentrated seawater;
extracting NaOH or HCl from the seawater;
adjusting pH of the seawater using the NaOH or the HCl; and
fixing carbon dioxide to a mineral source contained in the concentrated seawater by supplying gas containing the carbon dioxide to the concentrated seawater.

2. The carbon dioxide fixation method according to claim 1, wherein in the desalinating of the seawater, the fresh water and the concentrated seawater are separated using a reverse osmosis membrane.

3. The carbon dioxide fixation method according to claim 1, wherein carbon dioxide gas contained in exhaust gas discharged from a factory or a plant is supplied to the concentrated seawater.

4. The carbon dioxide fixation method according to claim 3, wherein the fresh water is used as a coolant for the factory or the plant that discharges the exhaust gas.

5. A carbon dioxide fixation system comprising:
a desalination unit configured to desalinate seawater to produce fresh water and concentrated seawater;
an extraction unit configured to extract NaOH or HCl for adjustment of pH from the seawater; and
a fixation unit configured to fix carbon dioxide to a mineral source contained in the concentrated seawater by supplying gas containing the carbon dioxide to the concentrated seawater.
